(19) United States
(12) Patent Application Publication
(10) Pub. No.: US 2012/0075956 A1
(43) Pub. Date: Mar. 29, 2012

(54) MAG-PHASE PROCESS

(75) Inventors: Thaddeus J. Kurpiewski, Ambler, PA (US); Byron W. Tietjen, Baldwinsville, NY (US)

(73) Assignee: Lockheed Martin Corporation, Bethesda, MD (US)

(21) Appl. No.: 12/893,709

(22) Filed: Sep. 29, 2010

(51) Int. Cl. G01S 15/00

(52) U.S. Cl. 367/87

(57) ABSTRACT

An active sonar system comprising a transmitter for providing a sonar signal, a receiver for receiving a reflected return signal, a processor of processing and extracting both magnitude and phase information from the return signal, and display unit for presenting both magnitude and phase information from the return signal to an operator.

### FIELD OF THE INVENTION

The present invention relates to sonar systems, more particularly, to a sonar system for processing and displaying active sonar return signals.

### BACKGROUND

Civilian and military sea vessels use both active and passive sonar systems for numerous purposes including geological studies, marine life exploration, and military operations such as anti-submarine warfare (ASW). These systems are used to detect the presence of submerged objects by either transmitting a sound wave and detecting its reflected return signal as it propagates through the water (active sonar), or by listening for sound waves generated by these objects (passive sonar).

These return signals are received, processed, and analyzed in an effort to detect a target object. Traditional processing methods include converting the received analog signal to a digital form, filtering, and processing the signal in either the time-domain or frequency-domain using, for example, a Fast Fourier Transform (FFT). The magnitude of the processed signal, as well as its bearing and range, is presented to a sonar operator through, for example, a rasterized display, wherein a target may be visually detected by identifying displayed differences in return signal magnitude.

However, the magnitude of the return signal may be distorted by the propagation medium (normally water), as well as the characteristics of the reflecting object, for example a target or the seafloor. Specifically, signal distortion or other interference may be introduced by any number of factors including: irregular seafloors, reverberation, target scattering, multi-path reflections, noise generated by waves, and changing distances from a target. These interferences are transmitted along with the return signal to the operator's display, thus distorting or masking the image of potential targets and hindering an operator's ability to detect their presence. This is especially true in littoral waters, where scattering and reverberation off of the seafloor creates significant amounts distortion, thus allowing a threat to remain undetected, especially when positioned on or near the seafloor.

As a result, current sonar systems may offer effective target detection only when return signal magnitude levels are above background noise or reverberation magnitude levels. However, when the magnitude of a return signal is less than or approximately equal to the background noise magnitude, systems displaying only return signal magnitude data to an operator are ineffective. Current solutions to these shortcomings include using various waveform types (FM, short pulse, wideband) or lowering the emitted power to reduce scattering. These methods are only marginally effective and still result in high false alarm rates and missed contacts. Other methods use multi-static techniques which are complicated and require multiple sensors or sonar platforms in addition to having a limited effectiveness.

Accordingly, a sonar system which improves an operator's ability to detect submerged objects in high-distortion environments is desired.

### SUMMARY

In one embodiment of the present invention a sonar system is provided having a transmitter for generating a sonar signal, a receiver for receiving a reflected return signal, and a signal processor for extracting both the magnitude and phase of the reflected return signal. The magnitude and phase data is provided to an operator via a visual display to aid detection of a target object. In a more preferred embodiment, the magnitude and phase data are superimposed, creating a single image representing the magnitude and phase of the return signal.

In another embodiment of the present invention a method for detecting a submerged object using a sonar system is provided. The method includes transmitting at least one sonar signal and receiving a reflected return signal. A signal processor is provided for processing the return signal and extracting both magnitude and phase data therefrom. An object or target is detected by analyzing a visual representation of the return signal magnitude and phase.

### BRIEF DESCRIPTION OF THE DRAWINGS

FIG. 1 is a block diagram of an exemplary active sonar system which may be used with an embodiment of the present invention.

FIG. 2 is a block diagram of a sonar system according to an embodiment of the present invention.

FIG. 3 is a graphical representation of an exemplary sonar operator screen displaying traditional return signal magnitude.

FIG. 4 is a graphical representation of a sonar operator screen according to an embodiment of the present invention displaying the phase of the return signal.

FIG. 5 is a graphical representation of a sonar operator screen according to an embodiment of the present invention displaying superimposed phase and magnitude data of equal weighting (50% magnitude, 50% phase).

FIG. 6 is a graphical representation of the sonar operator screen displaying superimposed magnitude and phase data with an approximate weighting of 70% magnitude and 30% phase.

FIG. 7 is a graphical representation of the sonar operator screen displaying superimposed magnitude and phase data with an approximate weighting of 30% magnitude and 70% phase.

### DETAILED DESCRIPTION OF PREFERRED EMBODIMENTS

It is to be understood that the figures and descriptions of the present invention have been simplified to illustrate elements that are relevant for a clear understanding of the present invention, while eliminating, for purposes of clarity, many other elements found in typical active sonar systems. However, because such elements are well known in the art, and because they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout several views.

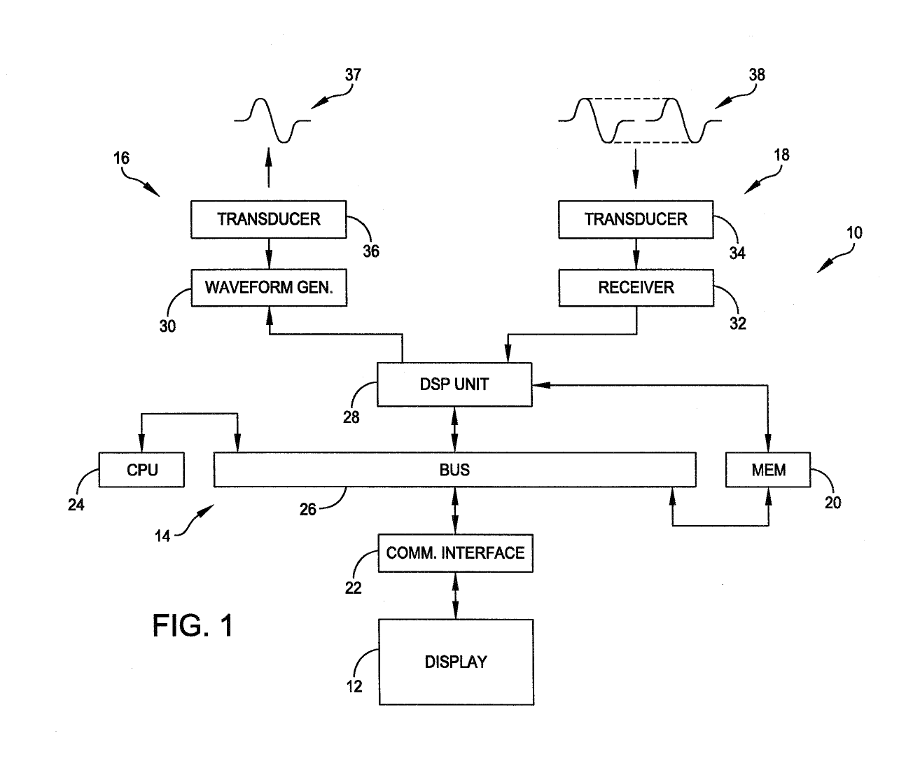

Referring generally to FIG. 1, a block diagram of an exemplary sonar system 10 is provided from which the general operation of an active sonar system will be described, including a system comprising embodiments of the present invention. The active sonar system 10 includes an operator interface 12, a processing computer 14, and sonar transmitting/receiving means 16,18. The processing computer 14 may utilize memory 20, such as ROM and/or RAM, an interface 22 for connecting input/output hardware, such as operator interface 12, a central processing unit (CPU) 24, and a digital signal processor (DSP) 28, each coupled to a data bus 26. The operator interface 12 may comprise a display screen and/or input devices, such as a keyboard and/or mouse for operational control of the sonar system.

The DSP 28 may take inputs from the processing computer 14 to drive a waveform generator 30, such as a synthesizer, for providing a signal to at least one transducer 36 for transmitting a sonar signal 37. In operation, the transmitted sonar signal 37 is reflected of an object or target, and produces a return signal 38. The return signal 38 is received by at least one second transducer 34, for example, an array of piezoelectric-based hydrophones. The second transducer 34 provides an analog version of the reflected return signal to a receiver 32. The receiver 32 may include filters, amplifiers, and/or analog to digital converters for providing a digitized version of the return signal to the DSP 28. The DSP 28 may comprise a beamformer, signal filters, and/or demodulators to process the digitized return signal. Likewise, the DSP 28 may include FFT circuitry for converting the time-domain return signal to the frequency-domain.

The resulting return signal data (typically magnitude data) is transferred over the data bus 26, where it may be stored in memory 20 and/or provided to the operator interface 12, such as a display device. The display device may comprise a CRT, plasma, LCD, or other suitable display type for presenting the received return signal data to an operator in a visual manner, usually in the form of a range vs. bearing output.

An objective of the present invention is to improve the ability of an active sonar system to detect a submerged object by processing not only the magnitude of return signals, but also their phase. The phase of a reflected return signal is influenced by the acoustic impedance of the reflecting object. This acoustic impedance is a function of a number of characteristics of the object, most notably its density and Young's Modulus. Accordingly, the acoustic impedance of the target's background, i.e., the ocean and/or the ocean bottom, is typically distinct from the acoustic impedance of the target itself because of their differing material compositions. It follows that a target may be detected by evaluating the phase of the return signals, and more particularly, by detecting variations in return signal phase.

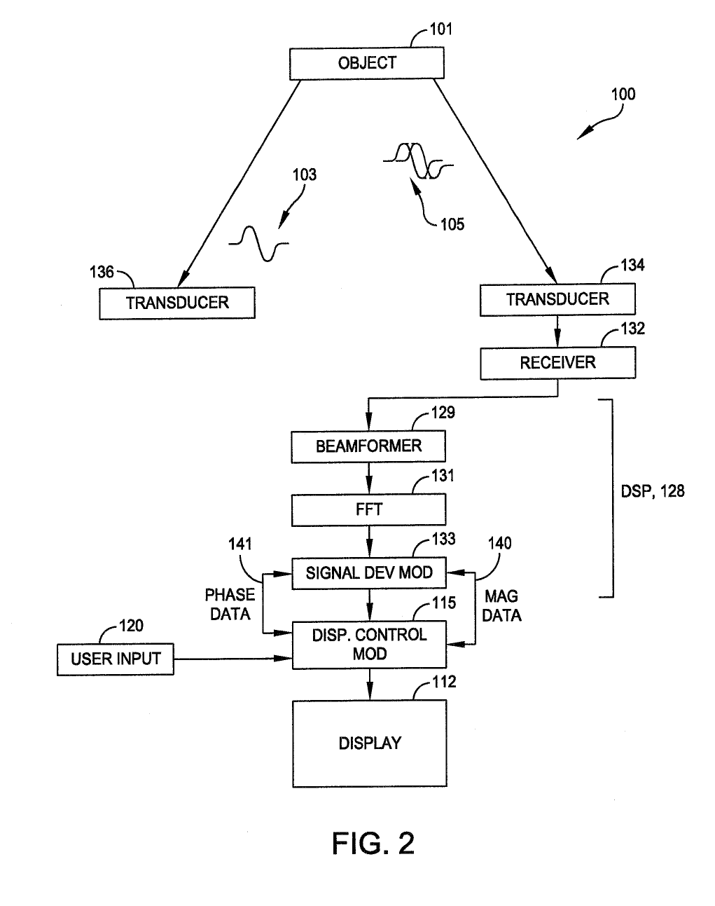

Referring to FIG. 2, a block diagram of an embodiment of the sonar system 100 of the present invention is provided. Similar to the arrangement described above with respect to FIG. 1, the sonar system 100 comprises at least one sonar transducer 136, such as a hydrophone configured to transmit a signal 103 through the water medium. The transmitted signal 103 is reflected off an object or target 101, producing a return signal 105 having an accompanying magnitude and phase. As indicated above, the phase of the return signal is dictated, in part, by the material properties of the target 101. The time-variant return signal 105 may take the general form:

x(t)=A*sin [(2πft)±θ]

wherein A is the magnitude of the return signal, f is its frequency, and θ is the signal phase.

A portion of the return signal 105 is received by at least one second transducer 134, for example an array of hydrophones. The at least one second transducer 134 provides a receiver 132 with an analog return signal representative of the received return signal 105. As described above with respect to FIG. 1, the receiver 132 may include an amplifier and/or associated filters as is known in the art, as well as an analog to digital converter for providing a DSP 128, including a beamformer 129, with a digitized version of the return signal. The beamformer 129 is operative to combine the received return signals to form one or more beams. Each beam is the result of a combination of the output signals of the at least one second transducer 134, and are arranged according to the direction of the received signals 105, while signals arriving from other directions are de-emphasized. In this way, the beamformer 129 operates as a type of special filter to separate the return signal from unwanted noise and interference.

In one embodiment of the present invention, the beam-formed return signal is provided to an FFT module 131. The FFT module 131 is used to convert the received time-domain return signal to its frequency-domain Fourier transform. The resulting Fourier transform may be provided to a processor, for example, a signal demodulator 133 for extracting both magnitude and phase data from the transform, with the phase of the transform being equal to the inverse tangent of the imaginary portion divided by the real portion.

While the above describes signal processing in the frequency-domain using an FFT, it is envisioned that the processing of the return signal and the extracting of magnitude and phase data can be accomplished in the time-domain without departing from the scope of the present invention.

In one embodiment of the present invention, the magnitude data 140 and phase data 141 are processed in parallel and provided to a display control module 115. The display control module 115 is operative to provide both the magnitude and phase data 140,141 to the operator display 112. In a preferred embodiment, the magnitude and phase data 140,141 is combined in the display control module 115 such that representative images of both magnitude and phase data are superimposed over each other on the operator display 112. This arrangement allows the operator to simultaneously observe both the magnitude data and the phase data of the returned signals.

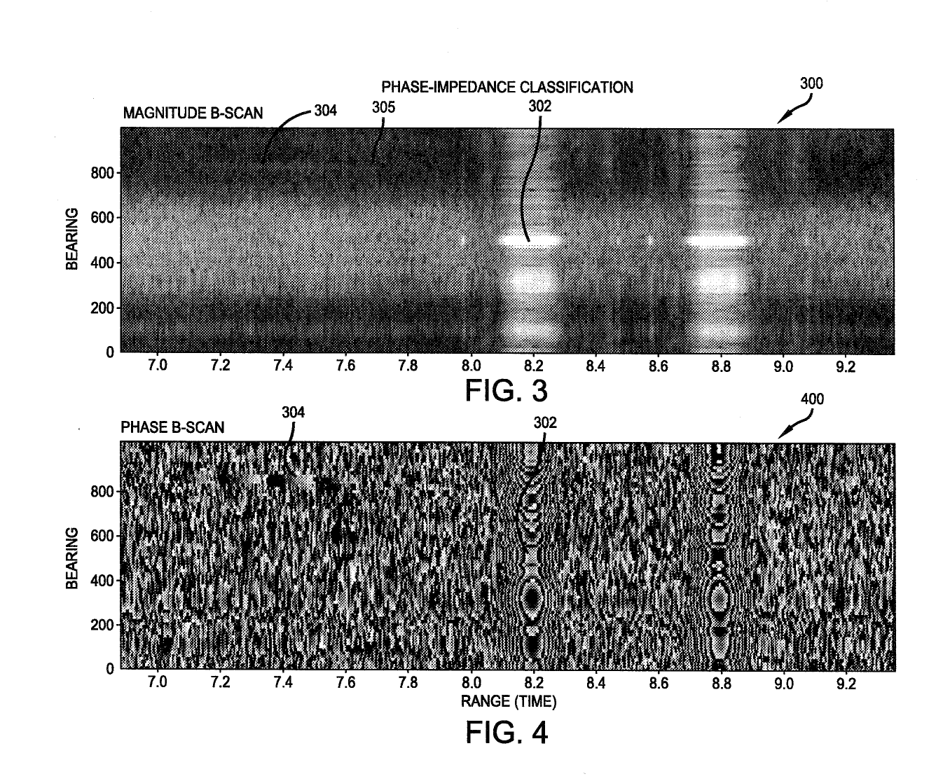

In another embodiment, as will be described in more with respect to FIGS. 3-7, the operator can change the relative weight of the magnitude and phase data displayed through, for example, an input device 120, so as to optimize the ability to detect targets according to varying conditions. For example, in shallow water the operator may wish to increase the weight of the phase data displayed, so as to avoid masking of potential targets by the above-described high interference levels typically accompanying shallow-water sonar magnitude scans.

It is to be understood that the above-described sonar system, including the arrangement and function of the receiver, DSP, and processing devices may be substituted with any number of suitable arrangements which result in the output of both magnitude and phase data of the received return signal without departing from the scope of the present invention. Likewise, while the combination of magnitude and phase data has been described with respect to a display control module, these operations may be performed by the display device itself, or other suitable devices without departing from the scope of the present invention.

Representative sonar displays will now be shown and described illustrating the above characteristics. Referring generally to FIG. 3, a sonar display 300 is provided showing a traditional magnitude scan. The display 300 is operative to show the position of a target according to its bearing and range relative to the host vessel. A definitive first target 302 appears on the display 300, however, an additional potential target 304 is obscured from reliable detection by an operator. This second target 304 is masked by, for example, the above-described scattering reflections and reverberations 305 having a similar magnitude to that of the return signal reflected off of the second target 304.

Improved target detection is provided by displaying the phase of return signal. As discussed herein, a target or other reflector will have a unique acoustic impedance which distinctly alters the phase of a signal reflected therefrom. Referring generally to FIG. 4, a sonar display 400 is shown and is operative to display only the phase of the return signal, as distinct from only the magnitude (FIG. 3). The first target 302 is still clearly visible, as the phase of the return signal reflected therefrom is distinct from the phase of the reflected signals off of the background medium, such as the water or the ocean floor. However, the presence of the second target 304 is distinctly more visible compared to the magnitude-only scan of FIG. 3. Specifically, where the high reverberation and scattering levels hid the target 304 in the magnitude scan, the phase scan permits “seeing through” this reverberation, by observing the phase difference between the reflected signal from the target and that of the background resulting from the individual acoustic impedance of the respective objects. Accordingly, the phase scan is extremely effective in revealing otherwise hidden targets in high-reverberant areas, for example, shallow waters.

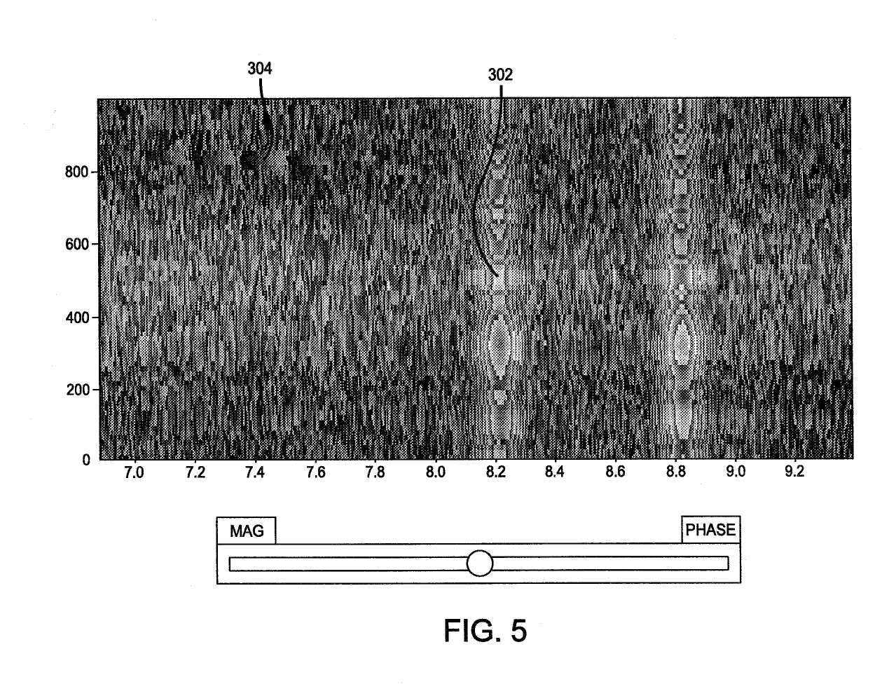

In an embodiment of the present invention shown in FIG. 5, the magnitude and phase data is combined or merged by superimposing respective images over one another. This arrangement allows an operator to see a high contrast image of the targets and the background based on both phase and magnitude. With respect to the figure, by displaying both magnitude and phase data with an equal weighting, the first target 302 and the second target 304 are visible to an operator.

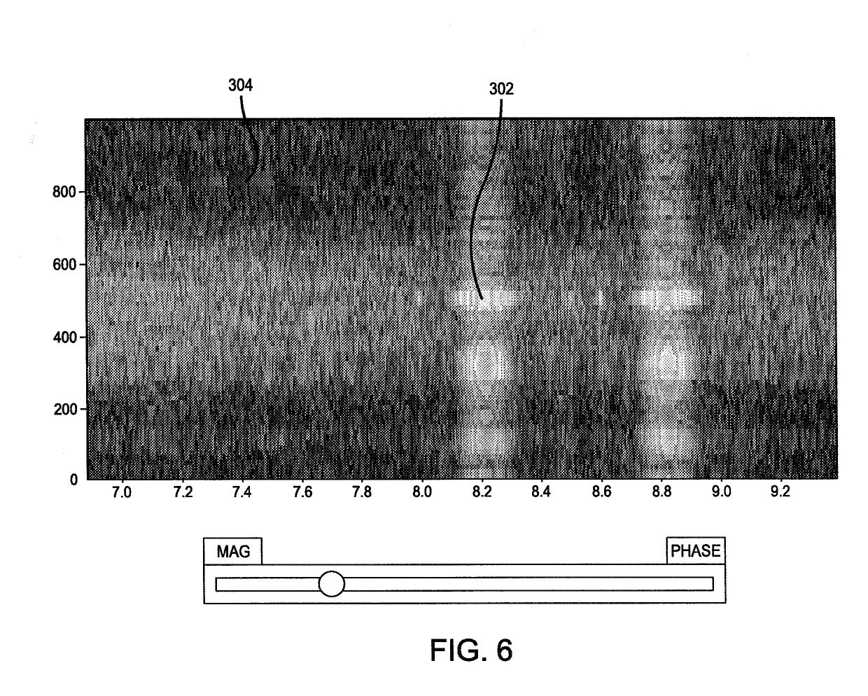

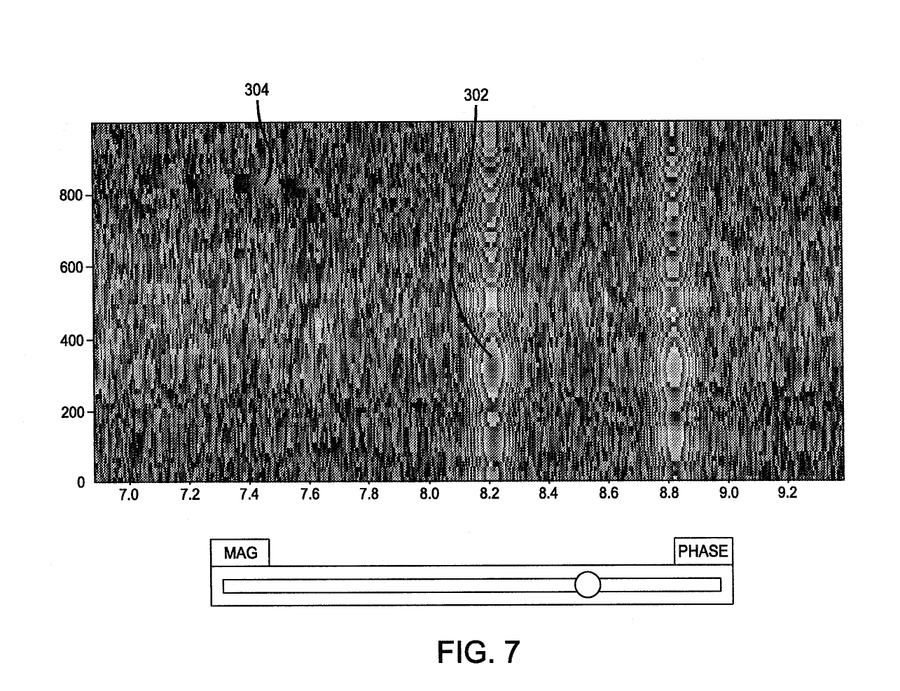

In a more preferred embodiment, the operator can also control the weighting, or relative strength of the superimposition based on environmental conditions. For example, FIGS. 6 and 7, show an approximate 70/30 and 30/70 weighting ratio of magnitude to phase data. This arrangement provides the operator with the ability to alter the weighting ratio according to changing conditions, or the types of targets being sought. For example, in deeper water, a magnitude-only scan may more clearly show the first target 302 (FIG. 3). However, when operating in shallow waters, or while targeting ships on the seafloor, the operator may wish to bias the scan to display more phase data or perform a phase-only scan which is capable of detecting the presence of a target in these high-interference environments, aiding the detection of the second target 304 (FIG. 4).

While the above describes superimposing phase and magnitude data onto a single operator screen, it is further envisioned that additional embodiments of the present invention may include separate displays of magnitude and phase data, either on individual operator displays, or by toggling between respecting images on a single display.

While the foregoing describes exemplary embodiments and implementations, it will be apparent to those skilled in the art that various modifications and variations can be made to the present invention without departing from the spirit and scope of the invention.

What is claimed is:

1. A sonar system comprising:
a receiver for receiving a sonar return signal, the return signal having a magnitude and a phase;
a signal processor coupled to the receiver, the signal processor configured to process and extract both the magnitude and phase of the return signal; and
an operator interface, the interface responsive to the return signal magnitude and phase for aiding target detection.

2. The system of claim 1, wherein the operator interface comprises a display.

3. The system of claim 2, wherein the display is operative to produce an image representative of the phase of the return signal.

4. The system of claim 3, wherein the display is operative to produce an image representative of both the magnitude and the phase of the return signal.

5. The system of claim 4, wherein the image representative of both the magnitude and phase of the return signal is formed by superimposing the image representative of the phase of the return signal, with an image representative of the magnitude of the return signal.

6. The system of claim 5, further comprising a controller for varying the relative weight of the superimposed images representative of the phase and magnitude of the return signal.

7. The system of claim 6, wherein the controller for varying the relative weight of the superimposed images is manipulated by an operator viewing the superimposed image.

8. The system of claim 1, wherein the signal processor further comprises a Fast Fourier Transform element for converting the return signal into the frequency-domain.

9. The system of claim 1, wherein the signal processor further includes a beamformer.

10. The system of claim 1, wherein the signal processor comprises a signal demodulator for extracting the phase and magnitude of the return signal.

11. A method for detecting an object comprising:
transmitting a signal;
receiving a reflected return signal, said return signal having a phase and a magnitude;
extracting phase and magnitude data of the return signal; and
providing the phase and the magnitude data to an operator display.

12. The method of claim 11, further comprising the step of displaying an image representative of the phase of the return signal on the operator display.

13. The method of claim 12, further comprising the step of displaying an image representative of the magnitude of the return signal on the operator display.

14. The method of claim 13, wherein the step of displaying the images representative of the phase and magnitude of the return signal includes superimposing the image representative of the magnitude of the return signal with the image representative of the phase of the return signal.

15. The method of claim 14, further comprising the step of selectively altering the weighting of the superimposition of the images representative of the phase and magnitude of the return signal.

16. The method of claim 11, wherein the step or extracting the phase and magnitude of the return signal is performed in the frequency-domain.

17. The method of claim 16, wherein the step of extracting phase and magnitude of the return signal in the frequency-domain further comprises processing the return signal using a Fast Fourier Transform, and extracting the magnitude and phase from the resulting transform.

18. The method of claim 11, wherein the step or extracting the phase and magnitude of the return signal is performed in the time-domain.
